(19) United States
(12) Patent Application Publication
(10) Pub. No.: US 2005/0188025 A1
(43) Pub. Date: Aug. 25, 2005

(54) Optimized collecting, processing and sharing of e-mail opt-out, unsubscribe or remove information

(76) Inventors: Michael Landau, Greenbrae, CA (US); Evan Horowitz, San Francisco, CA (US)

Correspondence Address: PERKINS COIE LLP, P.O. BOX 2168, MENLO PARK, CA, 94026, US

(21) Appl. No.: 10/774,343

(22) Filed: Feb. 5, 2004

(51) Int. Cl. G06F 15/16

(52) U.S. Cl. 709/206

(57) ABSTRACT

A method and system for optimized collecting, processing and sharing of e-mail opt-out, unsubscribe or remove information is disclosed. After opt-out or unsubscribe information is received or collected, it is stored in a database for subsequent processing, evaluation, distribution and updating. The information can then be utilized for optimized e-mail marketing by an entity.

### BACKGROUND OF THE INVENTION

1. Field of the Invention

The present invention relates to the efficient management and distribution of e-mail opt-out, unsubscribe and/or remove information.

2. State of the Art

Currently, sophisticated subscription databases and mailing systems exist on many levels. But little attention has been paid to develop sophisticated opt-out or unsubscribe techniques. Very few entities even attempt to classify opt-out information beyond labeling it as a simple “Remove.” Even “DO NOT E-MAIL” services simply provide limited “list washing” or “list cleaning” services for clients that remove addresses that should not be mailed. In addition, E-Mail Broadcasters lack sophisticated multi-channel source/distribution methods for opt-out and unsubscribe information, as such methods have not been imperative until recently. While many emailing systems have functionality that allow opt-out or unsubscribe e-mail lists to be imported and/or “checked against” or “purged,” those systems do not have sophisticated collection, sharing and distribution mechanisms for optimized use.

Over the last decade, the rapid growth of the Internet is in part due to the extreme popularity of e-mail as a form of communications. One consequence of this has been the tremendous growth of unsolicited e-mail, both commercial and non-commercial, otherwise known as SPAM. Although everyone's definition of SPAM varies slightly, new laws impose a burden to make sure that individuals who request not to be contacted, are not e-mailed again. With slight variations, this is known as a “DO NOT E-MAIL” list and is akin to the “DO NOT CALL” list associated with telemarketing.

In addition to the legal requirements that require opt-out and unsubscribe procedures, the new level of complexity involved with specialized hardware, list and campaign management among the various “entities” involved in sending e-mail demands more sophisticated and efficient use of opt-out information.

The “entities” involved can be broadly classified into three main categories:

The “List Owner” is the legal owner of the “relationship” with the e-mail address, presumably with the right to repeatedly communicate with the individual who receives e-mail to the address. It is assumed that the relationship exists until the recipient requests not to be e-mailed any more.

The “Product/Service Provider” relates specifically to the content or nature of the e-mail. In the case of an advertisement, this refers to the thing or things (products or services) that are being advertised or promoted in the e-mail.

The “E-mail Broadcaster” is the entity that actually sends/delivers the e-mail from a technical standpoint. Normally this implies that it is the Email Broadcaster's servers that are sending the e-mail.

The above entity “roles” can be filled by one single entity/organization or multiple entities that specialize in a particular function. For example, one company might own the list, provide the service advertised, and send the e-mail in-house. But increasingly, list owners want to diversify what they promote or advertise beyond the scope of their specialized field. In addition, well-developed e-mailing services exist to handle the technical complexity of actually sending the e-mail. Many of these companies cater to entities whose e-mail lists are in the hundreds of thousands or millions, and require very specialized hardware and software.

In the event that there are separate organizations or companies involved with the sending of any particular e-mail as described above, a number of problems arise.

Compliance—

In terms of best practices or legal compliance, it becomes necessary to timely distribute (or make available) information to avoid e-mailing an individual who has recently requested to opt-out or unsubscribe.

Efficiency/Optimization—

Depending on the context of the opt-out or unsubscribe request, it becomes necessary to limit or classify the scope of the request.

Automation—

Because of the new level of complexity added by compliance issues and optimization needs, a certain level of automation is needed to streamline the process and also avoid human error and/or delay.

And even if only one entity is involved, current systems do not provide more than minimal opt-out or unsubscribe information management that hardly addresses the issues above.

In light of the above defeciencies and the ever evolving nature of the business, what is needed are certain list management functionality with numerous additional features to facilitate collecting, processing, sharing and using the information with all entities in mind.

### BRIEF DESCRIPTION OF THE DRAWINGS

The invention, together with further advantages thereof, may best be understood by reference to the following description taken in conjunction with the accompanying drawings in which:

FIG. 1 is a sample Permission Spectrum illustrating the concept of “scope” of an opt-out request;

FIG. 2 is an example of a suitable embodiment of the invention;

FIG. 3 is a typical “DO NOT E-MAIL” real-time query use of the invention;

FIG. 4 is a sample evaluation of “best practices” or “legal standards” using the invention.

### DETAILED DESCRIPTION OF THE INVENTION

According to certain embodiments of the invention, a request is received to opt-out or unsubscribe e-mail(s) from future e-mailings of a particular entity or entities. The request may also contain contextual data about the request itself. The information in (and about) the request is then stored in a database for future reference.

Next, the information in the database is processed, shared and updated to facilitate best practices or legally compliant use of opt-out information. Sharing occurs when information is aggregated, processed and distributed to entities associated with an opt-out or remove request. Updating and further processing of the database occurs when subsequent opt-out requests are received, re-subscription occurs, or contextual data is added.

Additionally, the invention can be used as a real-time on-the-fly “DO NOT E-MAIL” query engine. The invention may also be used to collect and share opt-in subscription information.

The foregoing, and other objects, features and advantages of the invention will be apparent from the following detailed description of the suitable embodiment(s) which make(s) reference to several figures.

The outline below is a sample of a suitable embodiment of the invention:

A. Opt-Out/Unsubscribe Information Collection
Sample Methods
   Unsubscribe Submit Form
   Unsubscribe Link
   Suppression List Bulk Import
   Automated Complaint Parsing
Sample Features
Accompanying Contextual Data
   Scope of Request
   Source of Request
   Time/Date of Request
   IP Address of Request
   Other Data Associated with Request
Configurable Collection Methods
Synchronize data with external sources of opt-out, unsubscribe and remove information.

B. Opt-Out/Unsubscribe Information Management
Global Opt-Out/Unsubscribe Clearinghouse Relational Database
Complete Opt-Out History Archived
Database Updated as New Information is Collected
Secure/Encrypted Data

C. Opt-Out/Unsubscribe Sharing & Distribution
Types of Sharing & Distribution
   Real-Time Queries
   Unsubscribe/Remove File Export
   E-mail List Washing/Cleaning
Sample Methods
   File Transfer Protocol (FTP)—system can be configured to “drop” information to a remote server at a timed interval.
   Graphical User Interface—such as a web site login where the information can be downloaded from after authenticating a user.
   HTTP—such as a web site link which downloads the data.
   E-mail—such that information is sent to a user via e-mail.
   Automated Export to Mail Systems—information can interface directly with external mail programs to synchronize data or provide information in real-time.
Sample Features
   Configurable Distribution/Output Preferences
   Query/Processing Engine
      Rule-Based: strict evaluation of data & conditions to determine output.
   Learning-Based: adaptive/predictive evaluation of data & conditions to determine output.
      Configurable Rule Sets and Definitions

Paramount to understanding further use of the system requires an understanding of the possible “scope” of a particular opt-out or unsubscribe request, and how that scope can continually change. For example, one type of request could mean “NEVER E-MAIL ME AGAIN ABOUT ANYTHING” while another means “DO NOT E-MAIL ME ABOUT TOPIC A, BUT IT IS OK TO E-MAIL ABOUT OTHER TOPICS” while yet another means “DO NOT E-MAIL ME ABOUT ANYTHING EXCEPT TOPIC A”. The scope of a request may also target other types of preferences such as “I DO NOT WANT TO RECEIVE E-MAIL FROM COMPANY B” or “I DO NOT WANT TO RECEIVE COMMERCIAL E-MAIL”.

In deciding whether a prospective e-mail address is appropriate to send to, the “decision” or “confidence” engine might evaluate queries such as:
a) Does the e-mail address appear on a “DO NOT E-MAIL” list?
b) What is the content/topic/product/service of the e-mail to be sent?
c) What country is associated with the IP address used to unsubscribe?
d) What state is associated with the IP address used to unsubscribe?
e) Who is sending the e-mail?
f) Who owns the e-mail list?
g) Has the e-mail address complained to any SPAM reporting services?
h) How many opt-out requests exist for this e-mail address?
i) What are the known demographics of the e-mail address?

Based on all the evaluations, the system will determine an appropriate answer and/or confidence level. Other possible queries to improve the evaluation process will be apparent to those skilled in the art.

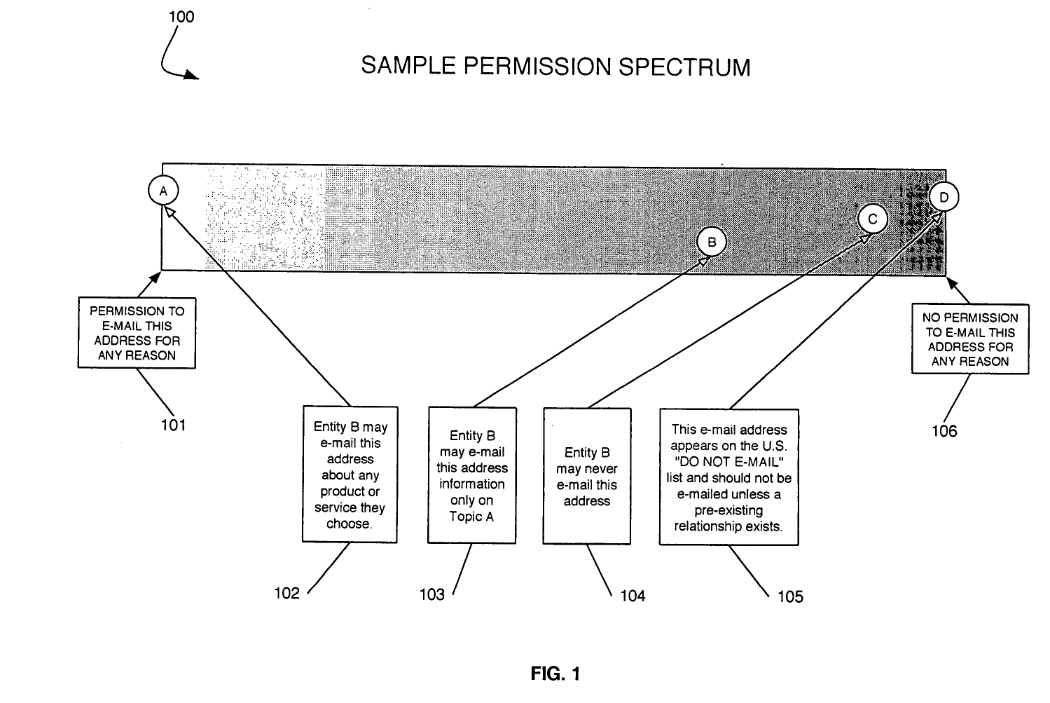

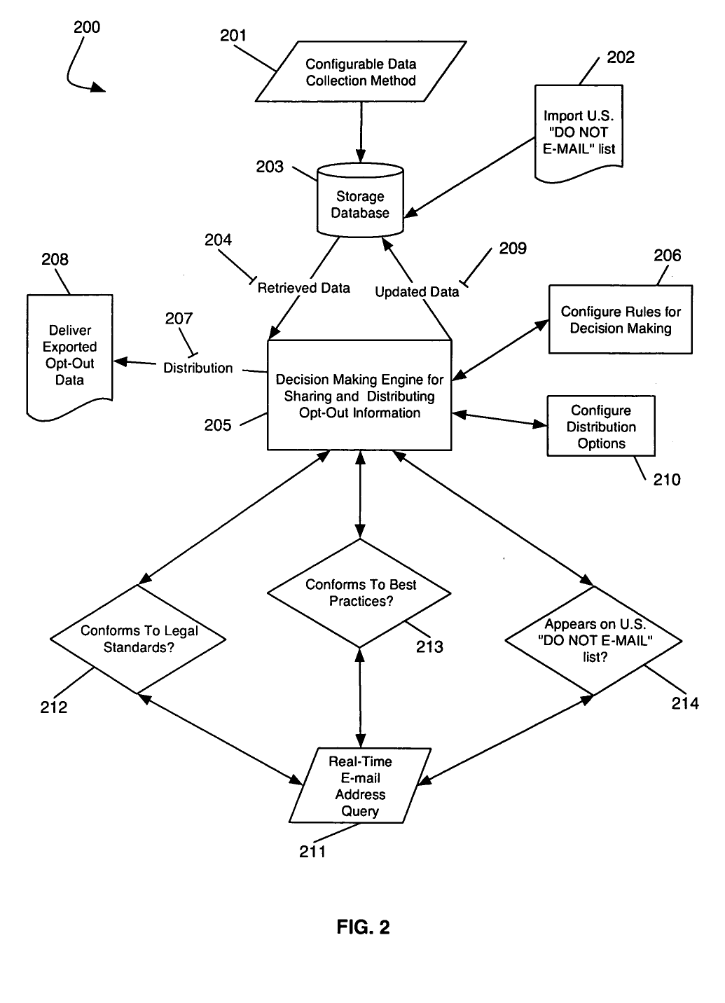

Turning next to FIGS. 1 and 2, a first embodiment of the present invention will be described. In a suitable embodiment 200 of FIG. 2, as a result of a data collection operation 201, opt-out or unsubscribe data is received by the invention. This data normally consists of an e-mail address and various contextual data which gives other information about the specific request. This information is typically transmitted via HTML forms, HTTP links, or imported in bulk via data file.

In an HTML form submission, an individual typically types in their e-mail address into a web page and presses “submit” to transmit the data. In some embodiments the e-mail address may already be pre-filled, such that only the “submit” need be pressed to transmit the data. When the information is collected via HTTP link, the user typically clicks on a web site URL to achieve this result. And when the collection occurs via imported data file, typically a list of e-mail addresses are sent, in bulk, to the system.

In a suitable embodiment, a user may configure how, and to what extent, opt-out or unsubscribe information is collected, 201. In a further embodiment, the opt-out or unsubscribe information is collected by parsing an e-mail for valid e-mail opt-out or unsubscribe information. Other methods of collecting or importing opt-out or unsubscribe information will be apparent to those skilled in the art.

However the information is collected, contextual data may accompany an e-mail address. Sample contextual data includes:
a) Source/Referral/Affiliate Information
b) Time/Date Information
c) Subscription Information
d) Demographic/Geographic Information
e) IP Address
f) Other data that might affect the scope of the opt-out or unsubscribe request.
g) Any other data the system may want to reference later.

Next, in data storage and processing operations 203, the collected opt-out and unsubscribe information is archived for subsequent use. In a suitable embodiment of the invention, all information received about an e-mail, over subsequent data collections, is archived and updated as necessary, 209.

Finally, in data sharing and distributing operations 205, the stored opt-out and unsubscribe information is retrieved 204 from the database 203, and processed according to established and re-configurable rules. Distribution occurs at 207 when the information is delivered externally or exported.

An example of a Permission Spectrum is found in FIG. 1, 100, and is used to illustrate the concept of “scope.” As is evident in the diagram, permission questions sometimes entail more than a simple YES or NO answer. As such, the scope, breadth and type of all requests for a particular e-mail address are important for optimized usage.

The endpoints of the Permission Spectrum 101 and 106 represent opposite levels of permission to e-mail. Full permission is given at 101 to e-mail anything to an address, while no permission (a directive not to e-mail) is represented at 106. The other points on the spectrum, 102-105, indicate varying degrees of permission to e-mail based on relative position to the endpoints, 101 and 106. The positioning of these points are derived, in part, from processed contextual data.

For example, let's say that both Company A and Company B typically send e-mail about Company B's new product. Further, a recipient of the e-mail requests to Company A that they no longer wish to receive e-mail about Company B's product via e-mail. Thus, it becomes necessary for Company A to notify Company B of the request since the scope of the request affects Company B. In other words, it may not be sufficient for Company A to simply unsubscribe the e-mail address and not alert Company B of the request. Prior to this invention, this might be accomplished by providing more than one remove link within an e-mail, which requires a user to make repeated requests and is clumsy. This Invention improves and automates this process by providing a single configurable opt-out link, a clearinghouse database to assemble and store the data, and a process for intelligent sharing & distribution of the information. Basically, the system attempts to make an educated-decision by assembling all “remove” data about an e-mail address into a Permission Spectrum to see where a particular e-mail to be sent fits in.

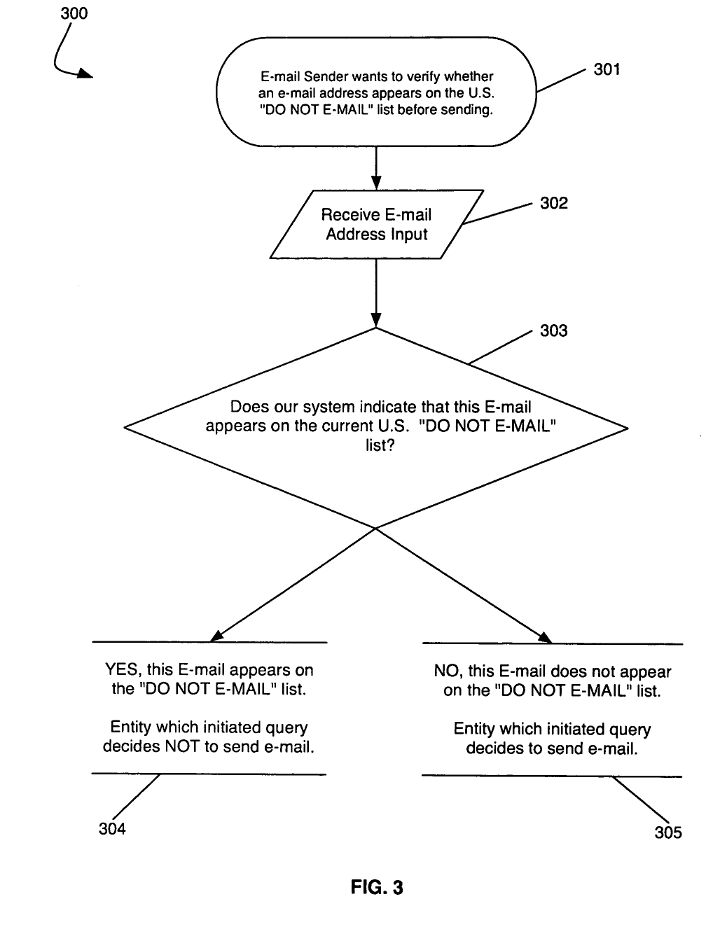

In a suitable embodiment, the system may be queried in real-time, and when provided with one or more email addresses and other contextual information, respond whether or not sending a particular e-mail conforms to “legal standards” or “best practices” for each e-mail address 211-214, 300, 400. In a simple example of this, FIG. 3, a query 301 can be made to determine whether the e-mail appears on the National “DO NOT E-MAIL” list. The system receives the input 302, and retrieves information about the queried e-mail address in step 303. If the information retrieved from the database, 203, indicates the address appears on the “DO NOT E-MAIL” the system responds affirmatively, 304. If the information retrieved indicates the address does not appear on the “DO NOT E-MAIL” the system responds as such, 305.

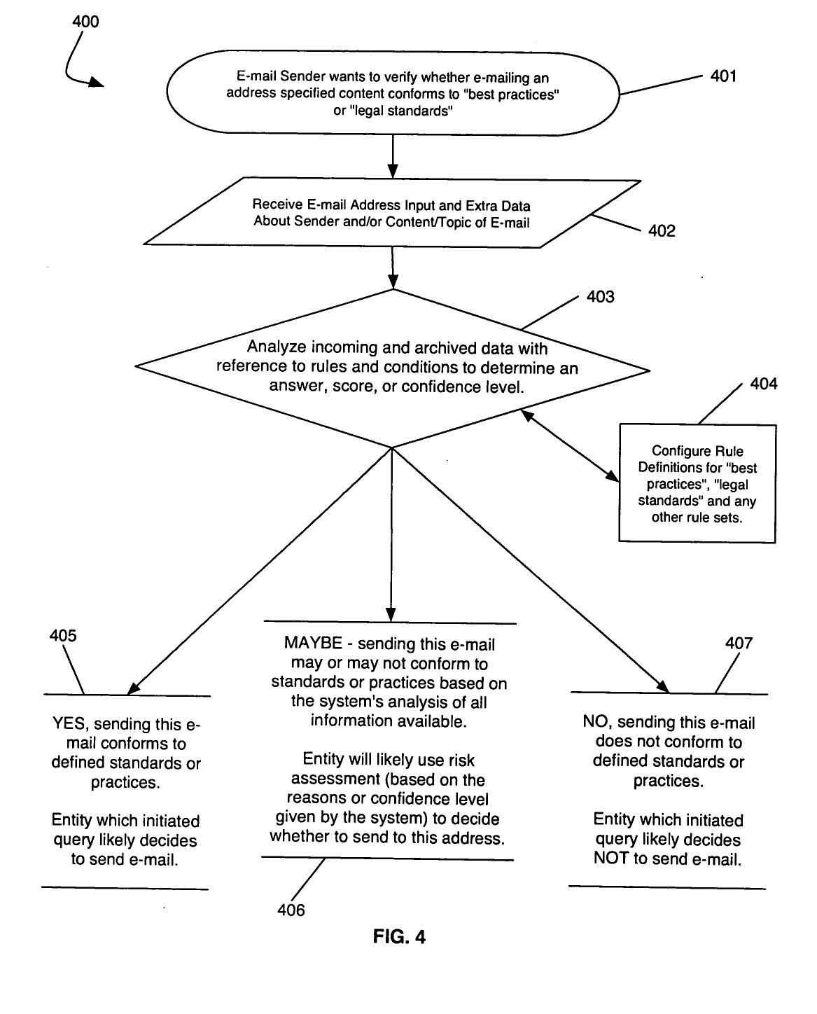

In a more complex example of this, a newsletter subscriber may have indicated that he or she does not want to receive more e-mails about “cooking” via an opt-out or unsubscribe request, but the entity sending the e-mail may want to check to make sure it is permissible to send e-mail on the subject of “bowling”. A query such as this can be processed through 401 in suitable embodiment 400 as shown in FIG. 4. At 402 the e-mail address and contextual data are received by the system. At 403 the information from the query is analyzed with the pertinent retrieved information from the database 203. 405-407 represent possible responses by process 403. Additionally, the manner in which the data is analyzed in process 403 is configurable in step 404.

Integration and use of 300 and 400 in suitable embodiment 200, is achieved in 211, 212, 213, and 214.

In another suitable embodiment, a user may configure how, and to what extent, opt-out or unsubscribe information is distributed, 210.

In another suitable embodiment, a user may configure definitions of “legal standards” and “best practices” for rule processing purposes, 206.

In yet another suitable embodiment, the system may synchronize information with external recipients of opt-out or unsubscribe information, 208. For example, the system may interface with external emailing systems to provide updated unsubscribe information to remote servers.

In yet another suitable embodiment, the system may synchronize information with external sources of opt-out or unsubscribe information, 202. For example, the system may interface with, and import, a National “DO NOT E-MAIL” list as provided by a U.S. authority.

In yet another suitable embodiment, the system may act as a list “cleaning” or “washing” service whereby an entire subscription list is evaluated against the database, and a “sanitized” or “purged” list is returned with the “removes” taken out.

In yet another suitable embodiment, all functions of the invention are performed in a secure or encrypted environment to prevent unauthorized access to sensitive information.

1. A method for managing opt-out or unsubscribe information comprising
collecting an e-mail address and contextual information for a user;
storing the e-mail address and contextual information in a database;
processing the e-mail address and contextual information for rule-based and learning-based use; and
distributing or sharing the e-mail address and contextual information, and derived processed data to an entity entitled to such information, at intervals or upon request.

2. A method as recited in claim 1, wherein the act of collecting opt-out or unsubscribe e-mail information includes:
input from a plurality of sources, including HTML form inputs, HTTP links, bulk text-file import, or other input mechanisms.

3. A method as recited in claim 1, further including:
configuring the act of collecting opt-out or unsubscribe e-mail information.

4. A method as recited in claim 1, further including:
selecting a distribution method from a plurality of methods including File Transport Protocol (FTP), E-mail, Hypertext Transfer Protocol (HTTP), Graphical User Interface (GUI), or other network transport mechanism.

5. A method as recited in claim 1, further including:
utilizing the database and processing mechanisms to conform to legal standards or best practices for e-mail marketing.

6. A method as recited in claim 5, further including:
configuring the definition of “legal standards” or “best practices.”

7. A method as recited in claim 1, further including:
utilizing the database and processing mechanisms to modify, update, or delete opt-out or unsubscribe information.

8. A method as recited in claim 1, further including:
utilizing the database and processing mechanisms for real-time “DO NOT E-MAIL” queries.

9. A method as recited in claim 1, further including:
utilizing the database and processing mechanisms to synchronize information with external sources of opt-out or unsubscribe information.

10. A method as recited in claim 1, further including:
utilizing the database and processing mechanisms to synchronize information with external recipients of opt-out or unsubscribe information.

11. A method as recited in claim 1, further including:
utilizing the database and processing mechanisms to collect, store, process and distribute opt-in or subscription information.

12. A method as recited in claim 1, further including:
utilizing the database and processing mechanisms for e-mail list “cleaning” of addresses to be removed.

13. A system for managing opt-out or unsubscribe information comprising:
means for collecting an e-mail address and contextual information for a user;
means for storing the e-mail address and contextual information in a database;
means for processing the e-mail address and contextual information for rule-based and learning-based use; and
means for distributing or sharing the e-mail address and contextual information, and derived processed data to an entity entitled to such information, at intervals or upon request.

14. A system as recited in claim 13, wherein said opt-out or unsubscribe system is a sub-system of a system which also sends e-mail.

15. A system as recited in claim 13, wherein said opt-out or unsubscribe system is a sub-system of a system which also provides e-mail list management functions.

16. A system as recited in claim 13, further comprising means for collecting opt-out or unsubscribe e-mail information from a plurality of sources, including HTML form inputs, HTTP links, bulk text-file import, or other input mechanisms.

17. A system as recited in claim 13, further comprising means to configure the method for collection of opt-out or unsubscribe e-mail information.

18. A system as recited in claim 13, further comprising means to select a distribution method from a plurality of methods including File Transport Protocol (FTP), E-mail, Hypertext Transfer Protocol (HTTP), Graphical User Interface (GUI), or other network transport mechanism.

19. A system as recited in claim 13, further comprising means for utilizing the database and processing mechanisms to conform to legal standards or best practices for e-mail marketing.

20. A system as recited in claim 19, further comprising means to define or configure “legal standards” or “best practices.”

21. A system as recited in claim 20, further comprising means for utilizing the database and processing mechanisms to modify, update, or delete opt-out or unsubscribe information.

22. A system as recited in claim 20, further comprising means for utilizing the database and processing mechanisms for real-time “DO NOT E-MAIL” queries.

23. A system as recited in claim 20, further comprising means for utilizing the database and processing mechanisms to synchronize information with external sources of opt-out or unsubscribe information.

24. A system as recited in claim 20, further comprising means for utilizing the database and processing mechanisms to synchronize information with external recipients of opt-out or unsubscribe information.

25. A system as recited in claim 20, further comprising means for utilizing the database and processing mechanisms to collect, store, process and distribute opt-in or subscription information.

26. A system as recited in claim 20, further comprising means for utilizing the system for e-mail list “cleaning” of addresses to be removed.

27. A computer program embodied on a computer readable medium for managing opt-out or unsubscribe information, the computer program code comprising:
a code segment for collecting an e-mail address and contextual information for a user;
a code segment for storing the e-mail address and contextual information in a database;
a code segment for processing the e-mail address and contextual information for rule-based and learning-based use, and
a code segment for distributing or sharing the e-mail address, contextual information, and derived processed data to an entity entitled to such information, at intervals or upon request.

28. A computer program as recited in claim 27, further comprising a code segment for collecting opt-out or unsubscribe e-mail information from a plurality of sources, including HTML form inputs, HTTP links, bulk text-file import, or other input mechanisms.

29. A computer program as recited in claim 27, further comprising a code segment to configure the means for collection of opt-out or unsubscribe e-mail information.

30. A computer program as recited in claim 27, further comprising a code segment to select a distribution method from a plurality of methods including File Transport Protocol (FTP), E-mail, Hypertext Transfer Protocol (HTTP), Graphical User Interface (GUI), or other network transport mechanism.

31. A computer program as recited in claim 27, further comprising a code segment for utilizing the database and processing mechanisms to conform to legal standards or best practices for e-mail marketing.

32. A computer program as recited in claim 31, further comprising a code segment to define or configure “legal standards” or “best practices.”

33. A computer program as recited in claim 27, further comprising a code segment for utilizing the database and processing mechanisms to modify, update, or delete opt-out or unsubscribe information.

34. A computer program as recited in claim 27, further comprising a code segment for utilizing the database and processing mechanisms for real-time “DO NOT E-MAIL” queries.

35. A computer program as recited in claim 27, further comprising a code segment for utilizing the database and processing mechanisms to synchronize information with external sources of opt-out or unsubscribe information.

36. A computer program as recited in claim 27, further comprising a code segment for utilizing the database and processing mechanisms to synchronize information with external recipients of opt-out or unsubscribe information.

37. A computer program as recited in claim 27, further comprising a code segment for utilizing the database and processing mechanisms to collect, store, process and distribute opt-in or subscription information.

38. A computer program as recited in claim 27, further comprising a code segment for utilizing the database and processing mechanisms for e-mail list “cleaning” of addresses to be removed.
